(19) United States
(12) Patent Application Publication
(10) Pub. No.: US 2024/0401302 A1
(43) Pub. Date: Dec. 5, 2024

(54) WORK MACHINE

(71) Applicant: TADANO LTD., Kagawa (JP)

(72) Inventors: Manato SHIRAI, Kagawa (JP); Masahide ZUSHI, Kagawa (JP)

(73) Assignee: TADANO LTD., Kagawa (JP)

(21) Appl. No.: 18/700,733

(22) PCT Filed: Oct. 25, 2022
(86) PCT No.: PCT/JP2022/039763

§ 371 Date: Apr. 12, 2024

(30) Foreign Application Priority Data
Oct. 29, 2021 (JP) 2021-178083
Jun. 17, 2022 (JP) 2022-098303

(51) Int. Cl. E02F 3/36; E02F 9/26

(52) U.S. Cl. CPC E02F 3/3622; E02F 9/264

(57) ABSTRACT

According to the present invention, a work machine comprises a plurality of booms that are extended and retracted by motive power from an actuator, a first pin that is moved by a first spring to connect the boom and the actuator and is moved by motive power from a motor to release a connection of the boom and the actuator, a second pin that is moved by a second spring to connect adjacent booms and is moved by motive power from the motor to release a connection of the adjacent booms, and a first detection device and a second detection device that detect the positions of the first pin and the second pin on the basis of the rotation of a rotary member that is rotated by motive power from the motor.

### TECHNICAL FIELD

The present invention relates to a work machine including a telescopic boom.

### BACKGROUND ART

A mobile crane including a telescopic boom having a plurality of booms and a hydraulic actuator for extending the telescopic boom is disclosed (see Patent Literature 1)

The adjacent booms are connected to each other by a boom connecting pin. The boom (hereinafter referred to as a movable boom) of which the connection by the boom connecting pin is released is movable with respect to another boom.

The actuator includes a rod member and a cylinder member. The cylinder member is releasably coupled to the movable boom by a cylinder connecting pin. When the cylinder member is displaced in an extension/retraction direction while being connected to the movable boom, the movable boom moves together with the cylinder member. Then, the telescopic boom extends and retracts.

### CITATION LIST

### Patent Literature

Patent Literature 1: JP 2012-96928 A

### SUMMARY OF THE INVENTION

### Problems to be Solved by the Invention

In the crane as described above, a technique for detecting the positions of the boom connecting pin and the cylinder connecting pin is required in order to accurately control a telescoping operation of the telescopic boom.

An object of the present invention is to provide a work machine capable of accurately controlling a telescoping operation of a telescopic boom.

### Solutions to Problems

According to an aspect of the present invention, a work machine includes:
a plurality of booms that are extended and retracted by motive power from an actuator;
a first pin that is moved by a first spring to connect the boom and the actuator to each other and is moved by motive power from a motor to release a connection of the boom and the actuator;
a second pin that is moved by a second spring to connect adjacent booms of the booms and is moved by motive power from the motor to release a connection of the adjacent booms; and
a first detection device and a second detection device that detect positions of the first pin and the second pin on the basis of a rotation of a rotary member that is rotated by motive power from the motor.

### Effects of the Invention

According to the present invention, it is possible to provide a work machine capable of accurately controlling a telescoping operation of a telescopic boom.

### BRIEF DESCRIPTION OF DRAWINGS

FIG. 1 is a schematic view of a mobile crane according to an embodiment.

FIGS. 2A to 2E are schematic views for explaining a structure and a telescoping operation of a telescopic boom.

FIG. 3 is a side view of a pin moving module.

FIG. 4 is a view of the pin moving module as viewed from arrow Aa in FIG. 3.

FIG. 5 is a view of the pin moving module as viewed from arrow A_{b} in FIG. 3.

FIG. 6 is a view of a detection device as viewed from arrow Aa in FIG. 3.

FIG. 7 is a cross-sectional view taken along line X₁-X₁ of FIG. 6 for explaining a first detection device.

FIG. 8 is a cross-sectional view taken along line X₂-X₂ of FIG. 6 for explaining the first detection device.

FIG. 9 is a view illustrating the pin moving module in which a boom connecting mechanism is in an extended state and a cylinder connecting mechanism is in an extended state.

FIG. 10A is a schematic view for explaining an operation of the cylinder connecting mechanism.

FIG. 10B is a schematic view for explaining an operation of the cylinder connecting mechanism.

FIG. 10C is a schematic view for explaining an operation of the cylinder connecting mechanism.

FIG. 11A is a schematic view for explaining an operation of the boom connecting mechanism.

FIG. 11B is a schematic view for explaining an operation of the boom connecting mechanism.

FIG. 11C is a schematic view for explaining an operation of the boom connecting mechanism.

FIG. 12 is a timing chart for explaining an operation of the pin moving module.

FIG. 13 is a table for explaining a detection operation of a position information detection device.

### DESCRIPTION OF EMBODIMENTS

Hereinafter, an example of an embodiment of the present invention will be described in detail with reference to the drawings. Note that the present invention is not limited to the embodiment described below.

### EMBODIMENT

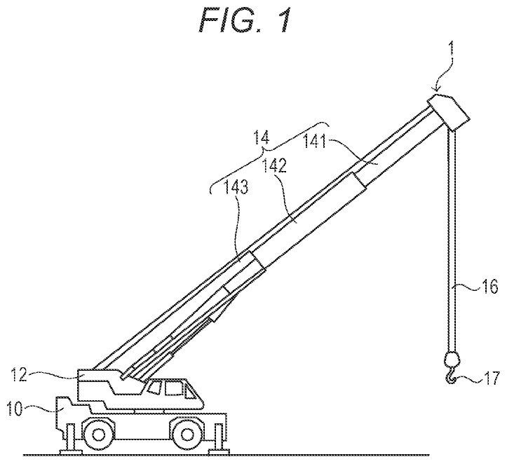

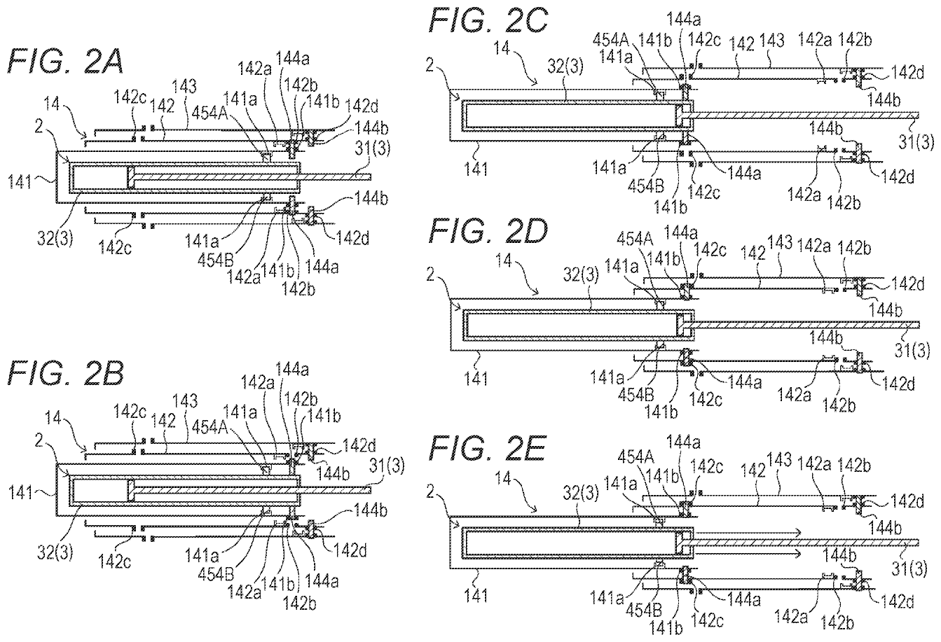

An outline of a mobile crane 1 according to the present embodiment will be described with reference to FIG. 1 and FIGS. 2A to 2E.

The mobile crane is, for example, a rough terrain crane, an all-terrain crane, a truck crane, or a truck loader crane. However, the work machine is not limited to the mobile crane, and may be various work machines (e.g., a high-place work vehicle) including a telescopic boom.

The mobile crane 1 includes a telescopic boom 14 and an actuator 2. The telescopic boom 14 includes a plurality of booms telescopically combined together. Adjacent booms are connected to each other by boom connecting pins (boom connecting pins 144a and 144b).

The actuator 2 moves the telescopic boom 14 in an extension/retraction direction when extending/retracting the telescopic boom 14. At this time, the actuator 2 is connected to a boom to be moved via cylinder connecting pins 454A and 454B, and releases the connection between the boom to be moved and a boom adjacent to the boom to be moved.

In the telescoping operation of the telescopic boom 14, the cylinder connecting pin and the boom connecting pin are moved by motive power from an electric motor 41. In order to control the telescoping operation of the telescopic boom, position information of the cylinder connecting pin and the boom connecting pin is required.

Therefore, in the present embodiment, a position information detection device 5 is provided to detect the position information of the cylinder connecting pin and the boom connecting pin. In particular, the position information detection device 5 includes two systems of detection devices (a first detection device 51 and a second detection device 52 to be described below). Hereinafter, the mobile crane 1 according to the present embodiment will be specifically described.

As illustrated in FIG. 1 and FIGS. 2A to 2E, the mobile crane 1 includes a vehicle body 10, a turning table 12, a telescopic boom 14, an actuator 2, a wire rope 16, and a hook 17.

The turning table 12 is turnably provided on an upper side of the vehicle body 10. A proximal end portion of the telescopic boom 14 is fixed to the turning table 12, and can be raised and lowered and can be extended and retracted. The actuator 2 extends and retracts the telescopic boom 14. The wire rope 16 is supported by the telescopic boom 14 and hangs down from a distal end portion of the telescopic boom 14. The hook 17 is provided at a distal end of the wire rope 16.

Next, as illustrated in FIGS. 1 and 2A to 2E, the telescopic boom 14 has a plurality of booms combined in a telescopic manner. Specifically, the plurality of booms is, in order from the inside, a distal boom 141, an intermediate boom 142, and a proximal boom 143.

The telescopic boom 14 extends sequentially from the boom disposed inside, and transitions from a retracted state illustrated in FIG. 2A to an extended state illustrated in FIG. 1. A plurality of intermediate booms may be provided. The distal boom 141 has a cylindrical shape and has an internal space capable of accommodating the actuator 2. The distal boom 141 has a pair of cylinder pin receiving portions 141a and a pair of boom pin receiving portions 141b at a proximal end portion thereof.

The pair of cylinder pin receiving portions 141a are provided to be coaxial with each other at the proximal end portion of the distal boom 141. The pair of cylinder pin receiving portions 141a can be engaged with and disengaged from the pair of cylinder connecting pins 454A and 454B provided on a cylinder member 32 of a telescopic cylinder 3, respectively.

Each of the cylinder connecting pins 454A and 454B is biased outward (in a direction from the proximal end portion to the distal end portion of each of the cylinder connecting pins 454A and 454B) by a first biasing mechanism 455 to be described below. The cylinder connecting pins 454A and 454B move inward (in a direction from the distal end portion to the proximal end portion of each of the cylinder connecting pins 454A and 454B) based on an operation of a cylinder connecting mechanism 45 to be described below.

In a state where the pair of cylinder connecting pins 454A and 454B and the pair of cylinder pin receiving portions 141a are engaged with each other, the distal boom 141 is movable in the extension/retraction direction together with the cylinder member 32. The pair of boom pin receiving portions 141b are provided to be coaxial with each other on a more proximal side than the cylinder pin receiving portions 141a. The pair of boom pin receiving portions 141b can be engaged with and disengaged from the pair of boom connecting pins 144a, respectively.

Each of the pair of boom connecting pins 144a is biased outward (in a direction from the proximal end portion toward the distal end portion of the boom connecting pin 144a) by a second biasing mechanism 463 to be described below. Each of the pair of boom connecting pins 144a connects the distal boom 141 and the intermediate boom 142 to each other. The pair of boom connecting pins 144a moves inward (in a direction from the distal end portion toward the proximal end portion of the boom connecting pin 144a) based on an operation of a boom connecting mechanism 46 to be described below.

In a state where the distal boom 141 and the intermediate boom 142 are connected to each other by the pair of boom connecting pins 144a, the boom connecting pins 144a are inserted to bridge between the boom pin receiving portions 141b of the distal boom 141 and first boom pin receiving portions 142b or second boom pin receiving portions 142c of the intermediate boom 142.

In the state where the distal boom 141 and the intermediate boom 142 are connected to each other, the distal boom 141 is prohibited from moving with respect to the intermediate boom 142. On the other hand, in a state where the distal boom 141 and the intermediate boom 142 are not connected to each other, the distal boom 141 is movable with respect to the intermediate boom 142.

The intermediate boom 142 has a cylindrical shape and has an internal space capable of accommodating the distal boom 141. The intermediate boom 142 has a pair of cylinder pin receiving portions 142a, a pair of first boom pin receiving portions 142b, and a pair of third boom pin receiving portions 142d at a proximal end portion thereof, and has a pair of second boom pin receiving portions 142c at a distal end portion thereof.

The pair of cylinder pin receiving portions 142a and the pair of first boom pin receiving portions 142b are substantially similar to the pair of cylinder pin receiving portions 141a and the pair of boom pin receiving portions 141b of the distal boom 141, respectively. The pair of third boom pin receiving portions 142d are provided to be coaxial with each other on a more proximal side than the pair of first boom pin receiving portions 142b. A pair of boom connecting pins 144b are inserted into the pair of third boom pin receiving portions 142d, respectively. The pair of boom connecting pins 144b connects the intermediate boom 142 and the proximal boom 143 to each other.

The pair of second boom pin receiving portions 142c are provided to be coaxial with each other at the distal end portion of the intermediate boom 142. The pair of boom connecting pins 144a are inserted into the pair of second boom pin receiving portions 142c, respectively.

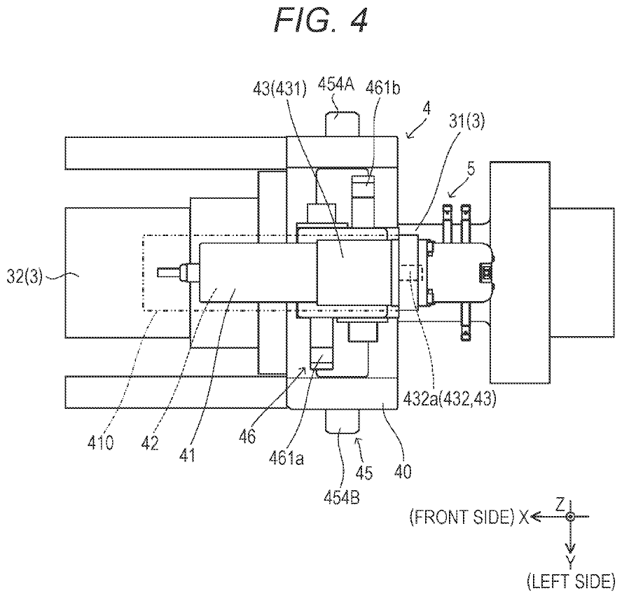

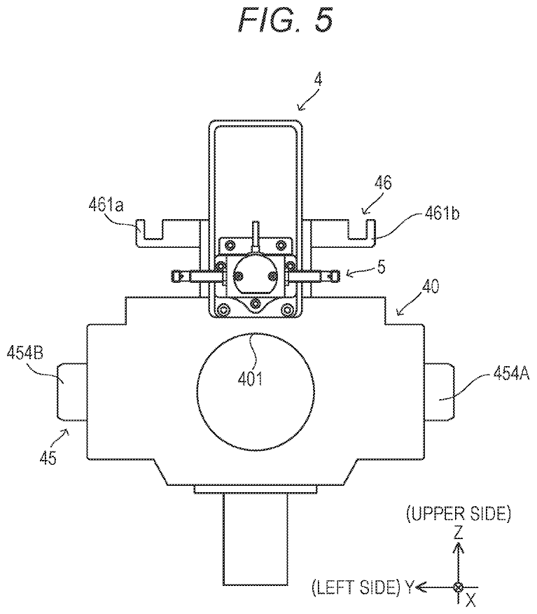

The actuator 2 is an actuator that extends and retracts the telescopic boom 14. As illustrated in FIGS. 2A to 11C, the actuator 2 includes a telescopic cylinder 3 and a pin moving mechanism 4. The actuator 2 is disposed in the internal space of the distal boom 141 in the retracted state of the telescopic boom 14 (the state illustrated in FIGS. 2A to 2E).

The telescopic cylinder 3 includes a rod member 31 and a cylinder member 32. The telescopic cylinder 3 moves a boom connected to the cylinder member 32 via cylinder connecting pins 454A and 454B to be described below.

### <Pin Moving Mechanism>

The pin moving mechanism 4 includes an electric motor 41, a brake mechanism 42, a transmission mechanism 43, a cylinder connecting mechanism 45, a boom connecting mechanism 46, and a position information detection device 5 supported by a trunnion 40.

Hereinafter, each member constituting the actuator 2 will be described based on a state in which each member is incorporated in the actuator 2. In the description of the actuator 2, an orthogonal coordinate system (X, Y, Z) is used. In the orthogonal coordinate system, the X direction coincides with the extension/retraction direction of the telescopic boom 14 mounted on the mobile crane 1. The positive side of the X direction is an extension direction of the extension/retraction direction. The negative side of the X direction is a retraction direction of the extension/retraction direction. In a state where a turning angle of the telescopic boom 14 is 0 degrees and a derricking angle of the telescopic boom 14 is 0 degrees (in a fully laid-down state), the positive side of the X direction coincides with the front side of the mobile crane 1. In the state where the turning angle of the telescopic boom 14 is 0 degrees and the derricking angle of the telescopic boom 14 is 0 degrees, the negative side of the X direction coincides with the rear side of the mobile crane 1.

Further, the Z direction coincides with, for example, the up-down direction of the mobile crane 1 in a state where the derricking angle of the telescopic boom 14 is 0 degrees. The Y direction coincides with, for example, the vehicle width direction (left-right direction) of the mobile crane 1 in a state where the telescopic boom 14 faces forward. Hereinafter, unless otherwise specified, the width direction or the left-right direction refers to the Y direction in the orthogonal coordinate system (X, Y, Z).

In a state where the mobile crane 1 is viewed from the rear toward the front, the left side is the positive side of the Y direction. In the state where the mobile crane 1 is viewed from the rear toward the front, the right side is the negative side of the Y direction. In the state where the mobile crane 1 is viewed from the rear toward the front, the upper side is the positive side of the Z direction. In the state where the mobile crane 1 is viewed from the rear toward the front, the lower side is the negative side of the Z direction.

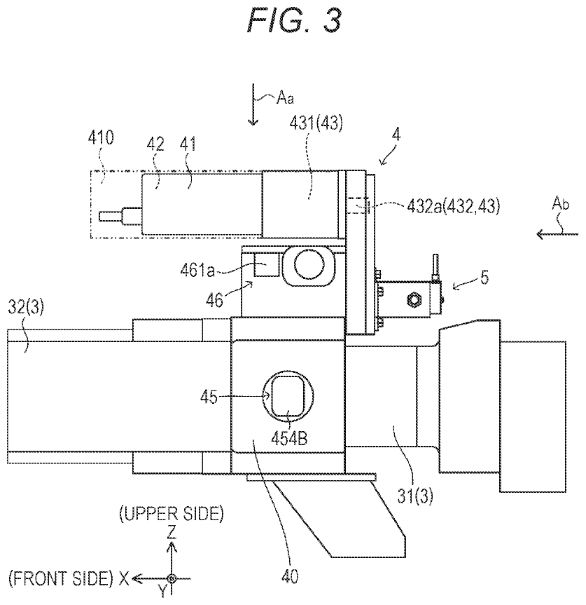

The trunnion 40 will be described with reference to FIGS. 3 to 5. The trunnion 40 has a support hole 401. The rod member 31 of the telescopic cylinder 3 is inserted into the support hole 401 in the X direction. The trunnion 40 is fixed to a proximal end portion (an end portion on the negative side of the X direction) of the cylinder member 32 of the telescopic cylinder 3. Therefore, the trunnion 40 moves together with the cylinder member 32.

The trunnion 40 supports the cylinder connecting mechanism 45 and the boom connecting mechanism 46. Furthermore, the trunnion 40 supports the electric motor 41, the brake mechanism 42, and the transmission mechanism 43 to be described below. In this manner, the trunnion 40 unitizes these elements. Such a configuration contributes to size reduction of the pin moving mechanism 4, improvement of productivity, and improvement of system reliability.

The trunnion 40 holds the right cylinder connecting pin 454A by a right pin support portion (not illustrated) provided on a right wall portion thereof. The right cylinder connecting pin 454A is movable in the left-right direction. The trunnion 40 holds the left cylinder connecting pin 454B by a left pin support portion (not illustrated) provided on a left wall portion thereof. The left cylinder connecting pin 454B is movable in the left-right direction.

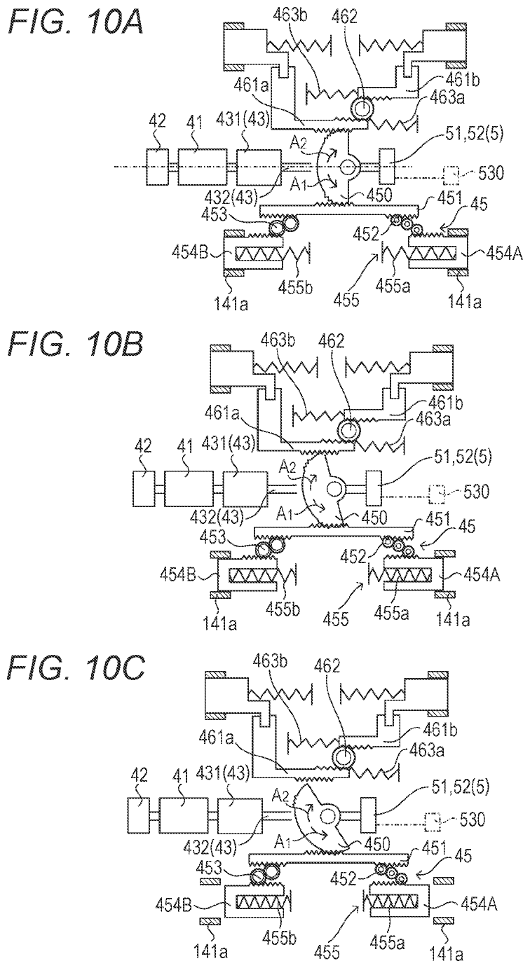

The electric motor 41 is fixed to a vertical transmission mechanism 432 via a decelerator 431. Such an electric motor 41 is covered with a cover 410 for waterproofing and dustproofing. As illustrated in FIG. 3, the electric motor 41 is provided above the trunnion 40. The decelerator 431 is connected to an output shaft of the electric motor 41 (see FIGS. 10A to 10C).

The electric motor 41 is connected to, for example, a power supply device (not illustrated) provided on the turning table 12, via a power supply cable. Furthermore, the electric motor 41 is connected to, for example, a control unit (not illustrated) provided on the turning table 12, via a control signal transmission cable.

The brake mechanism 42 applies a braking force to the electric motor 41. The brake mechanism 42 prevents the output shaft of the electric motor 41 from rotating in a stopped state of the electric motor 41. As a result, the state of the pin moving mechanism 4 is maintained in the stopped state of the electric motor 41.

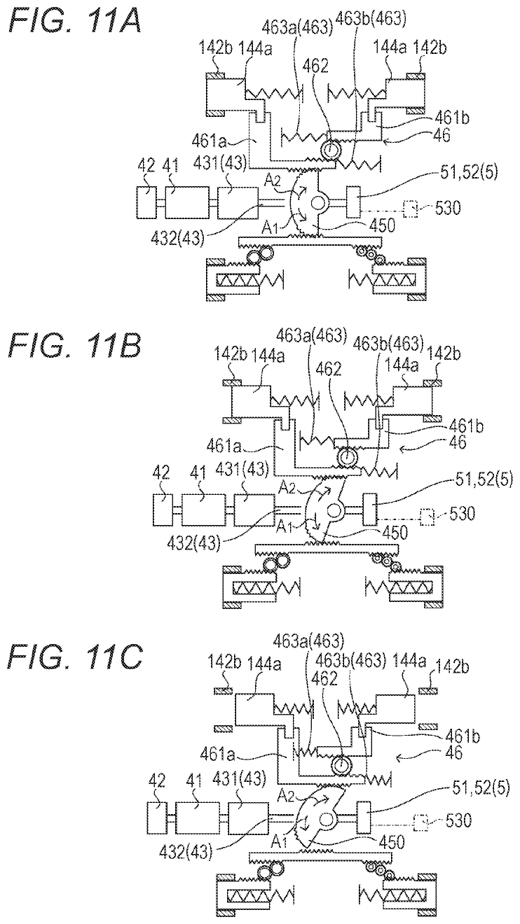

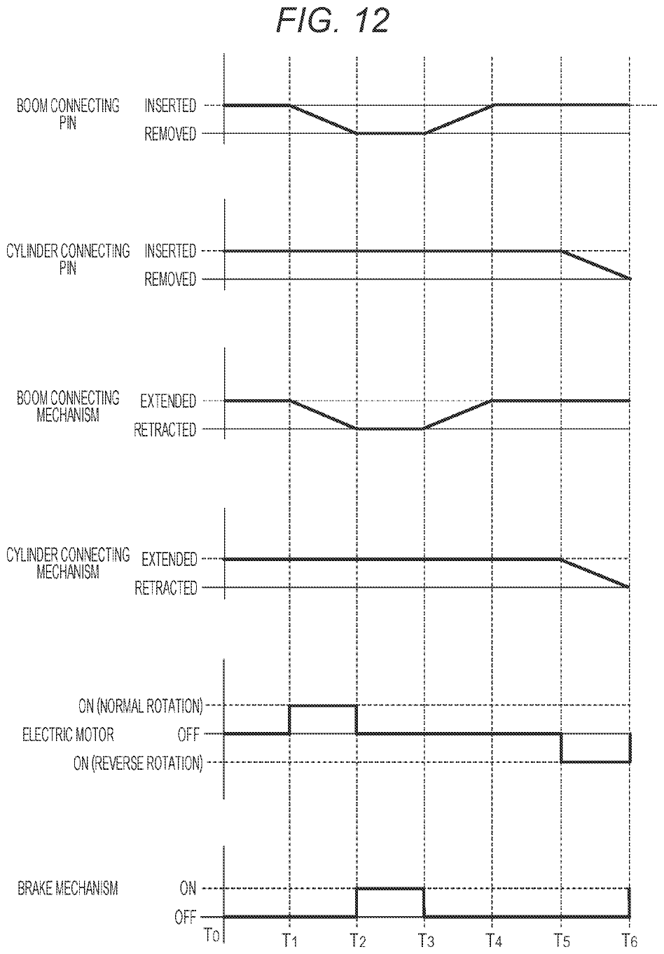

Specifically, the brake mechanism 42 operates in a retracted state of the cylinder connecting mechanism 45 or a retracted state of the boom connecting mechanism 46 to be described below to maintain the states of the cylinder connecting mechanism 45 and the boom connecting mechanism 46. The state of the brake mechanism 42 is switched by a control unit 530 (see FIGS. 10A to 11C). The state of the brake mechanism 42 may be switched on the basis of an operation of an operator.

The transmission mechanism 43 transmits motive power from the electric motor 41 to the cylinder connecting mechanism 45 and the boom connecting mechanism 46. The transmission mechanism 43 includes a decelerator 431 and a vertical transmission mechanism 432. The decelerator 431 decelerates the rotation of the electric motor 41 and transmits the decelerated rotation to the vertical transmission mechanism 432. The vertical transmission mechanism 432 transmits the rotation of the decelerator 431 to a switch gear 450 (FIGS. 10A to 10C) to be described below. In the present embodiment, the electric motor 41 is provided above the switch gear 450. Therefore, the vertical transmission mechanism 432 is configured to transmit the rotation of the electric motor 41 to the switch gear 450 provided below the electric motor 41.

Specifically, the vertical transmission mechanism 432 includes an upper transmission shaft 432a, a lower transmission shaft 432b, and a transmission gear (not illustrated). The upper transmission shaft 432a is provided to be coaxial with the output shaft of the electric motor 41. The upper transmission shaft 432a is connected to the decelerator 431.

The lower transmission shaft 432b corresponds to an example of a rotary member that rotates based on the motive power from the motor, and is provided in parallel with the upper transmission shaft 432a and below the upper transmission shaft 432a. The lower transmission shaft 432b is disposed to be coaxial with the switch gear 450 to be described below, and is connected to the switch gear 450. The rotary member that rotates based on the motive power from the motor is not limited to the lower transmission shaft 432b. The rotary member that rotates based on the motive power from the motor may be any member that rotates based on the motive power from the electric motor 41.

The transmission gear includes an upper gear (not illustrated) provided on the upper transmission shaft 432a and a lower gear (not illustrated) provided on the lower transmission shaft 432b. The upper gear and the lower gear are external gears, and are meshed with each other. The rotation of the decelerator 431 is transmitted to the switch gear 450 via the vertical transmission mechanism 432.

### <Cylinder Connecting Mechanism>

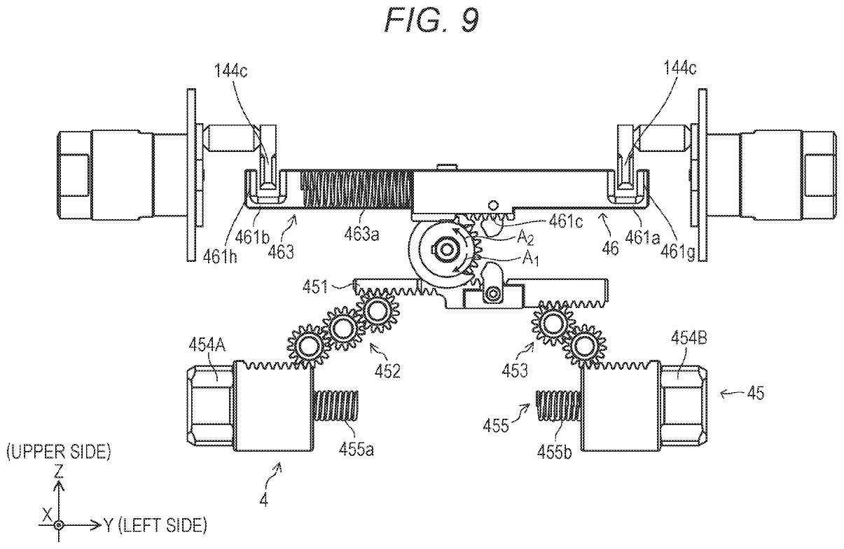

The cylinder connecting mechanism 45 operates based on motive power from the electric motor 41, transition in state between an extended state (see FIGS. 9 and 10A) and a retracted state (see FIG. 10C). The operation in which the cylinder connecting mechanism 45 transitions from the extended state to the retracted state is an operation of removing the cylinder connecting mechanism 45. The operation in which the cylinder connecting mechanism 45 transitions from the retracted state to the extended state is an operation of inserting the cylinder connecting mechanism 45.

In the extended state of the cylinder connecting mechanism 45, the pair of cylinder connecting pins 454A and 454B to be described below and a pair of cylinder pin receiving portions 141a of a boom e.g., the distal boom 141) are engaged with each other. In this engaged state, the boom and the cylinder member 32 are connected to each other.

In the retracted state of the cylinder connecting mechanism 45, the pair of cylinder connecting pins 454A and 454B and the pair of cylinder pin receiving portions 141a are disengaged from each other. In this disengaged state, the engagement between the boom and the cylinder member 32 is released.

Specifically, the cylinder connecting mechanism 45 includes a switch gear 450, a first rack bar 451, a first gear mechanism 452, a second gear mechanism 453, a pair of cylinder connecting pins 454A and 454B, and a first biasing mechanism 455.

The switch gear 450 has a teeth portion on a partial portion of an outer peripheral surface thereof. The switch gear 450 is externally fitted and fixed to the lower transmission shaft 432b of the transmission mechanism 43, and rotates together with the lower transmission shaft 432b. The switch gear 450 selectively transmits motive power from the electric motor 41 to one of the cylinder connecting mechanism 45 and the boom connecting mechanism 46.

In the following description, the rotation direction (the direction indicated by arrow A₁ in FIG. 10A) of the switch gear 450 when the cylinder connecting mechanism 45 transitions from the extended state to the retracted state is a first direction of the rotation direction of the switch gear 450. On the other hand, the rotation direction of the switch gear 450 (a direction indicated by arrow A₂ in FIG. 10A) when the cylinder connecting mechanism 45 transitions from the retracted state to the extended state is a second direction of the rotation direction of the switch gear 450.

The first rack bar 451 moves in its longitudinal direction (Y direction) as the switch gear 450 moves. The first rack bar 451 is located on the most positive side of the Y direction in the extended state of the cylinder connecting mechanism 45. On the other hand, the first rack bar 451 is located on the most negative side of the Y direction in the retracted state of the cylinder connecting mechanism 45.

The first rack bar 451 has a first rack teeth portion on an upper surface thereof. The first rack teeth portion meshes with the teeth portion of the switch gear 450 only during the above-described state transition.

In the extended state, when the switch gear 450 rotates by a predetermined amount in the first direction, the teeth portion of the switch gear 450 mesh with the first rack teeth portion of the first rack bar 451. When the switch gear 450 further rotates in the first direction from this state, the first rack bar 451 moves rightward in accordance with the rotation of the switch gear 450.

When the switch gear 450 rotates in the second direction from the extended state of the cylinder connecting mechanism 45, the first rack teeth portion of the first rack bar 451 and the teeth portion of the switch gear 450 do not mesh with each other.

Furthermore, the first rack bar 451 has a second rack teeth portion and a third rack teeth portion on a lower surface thereof. The second rack teeth portion meshes with the first gear mechanism 452 to be described below. The third rack teeth portion meshes with the second gear mechanism 453 to be described below.

The first gear mechanism 452 includes a plurality of gears (see FIG. 9) each of which is an external gear. The first gear mechanism 452 meshes with the second rack teeth portion of the first rack bar 451. The first gear mechanism 452 rotates as the first rack bar 451 moves. In addition, the first gear mechanism 452 meshes with a pin-side rack teeth portion of the right cylinder connecting pin 454A to be described below.

The second gear mechanism 453 includes a plurality of gears (see FIG. 9) each of which is an external gear. The second gear mechanism 453 meshes with the third rack teeth portion of the first rack bar 451. The second gear mechanism 453 rotates as the first rack bar 451 moves. In addition, the second gear mechanism 453 meshes with a pin-side rack teeth portion of the left cylinder connecting pin 454B to be described below.

As illustrated in FIG. 9 and FIGS. 10A to 10C, the pair of cylinder connecting pins 454A and 454B have center axes coinciding with each other in the left-right direction, and are coaxial with each other. Each of the pair of cylinder connecting pins 454A and 454B corresponds to an example of a first pin.

The right cylinder connecting pin 454A has a pin-side rack teeth portion on an outer peripheral surface thereof. The pin-side rack teeth portion of the right cylinder connecting pin 454A meshes with the first gear mechanism 452. The left cylinder connecting pin 454B has a pin-side rack teeth portion on an outer peripheral surface thereof. The pin-side rack teeth portion of the left cylinder connecting pin 454B meshes with the second gear mechanism 453.

The right cylinder connecting pin 454A having the above-described configuration is supported by the right wall portion of the trunnion 40. A movement of the right cylinder connecting pin 454A in an axial direction (left-right direction) is guided by the right wall portion of the trunnion 40.

The left cylinder connecting pin 454B is supported by the left wall portion of the trunnion 40. A movement of the left cylinder connecting pin 454B in the axial direction is guided by the left wall portion. The right cylinder connecting pin 454A moves in its axial direction as the first gear mechanism 452 rotates. Specifically, the right cylinder connecting pin 454A moves rightward (outward) when the cylinder connecting mechanism 45 transitions from the retracted state (see FIG. 10C) to the extended state (see FIG. 10A). On the other hand, the right cylinder connecting pin 454A moves leftward (inward) when the cylinder connecting mechanism 45 transitions from the extended state (see FIG. 10A) to the retracted state (see FIG. 10C).

The left cylinder connecting pin 454B moves in its axial direction as the second gear mechanism 453 rotates. Specifically, the left cylinder connecting pin 454B moves leftward when the cylinder connecting mechanism 45 transitions from the retracted state (see FIG. 10C) to the extended state (see FIG. 10A). On the other hand, the left cylinder connecting pin 454B moves rightward when the cylinder connecting mechanism 45 transitions from the extended state (see FIG. 10A) to the retracted state (see FIG. 10C).

When the cylinder connecting pins 454A and 454B move outward from the retracted state of the cylinder connecting pins 454A and 454B, the distal end portions of the cylinder connecting pins 454A and 454B protrude outward from both side surfaces of the trunnion 40 in the left-right direction. The state in which the cylinder connecting pins 454A and 454B move to the outermost side is referred to as an extended state of the cylinder connecting pins 454A and 454B. The cylinder connecting pins 454A and 454B are engaged with the cylinder pin receiving portions of the boom in the extended state.

The first biasing mechanism 455 returns the cylinder connecting mechanism 45 to the extended state when the electric motor 41 is in a non-energized state in the retracted state of the cylinder connecting mechanism 45. In other words, when the electric motor 41 is in a non-energized state (stopped state) and the brake mechanism 42 is in a turn-off state in the retracted state of the cylinder connecting mechanism 45, the first biasing mechanism 455 returns the pair of cylinder connecting pins 454A and 454B to reference positions.

Specifically, the first biasing mechanism 455 corresponds to an example of a first spring, and includes a pair of coil springs 455a and 455b (see FIGS. 10A to 10C). The right coil spring 455a normally biases the right cylinder connecting pin 454A. The direction in which the right coil spring 455a biases the cylinder connecting pin 454A coincides with the direction (right side) from the proximal end portion toward the distal end portion of the cylinder connecting pin 454A.

The left coil spring 455b normally biases the left cylinder connecting pin 454B. The direction in which the left coil spring 455b biases the left cylinder connecting pin 454B coincides with the direction (left side) from the proximal end portion toward the distal end portion of the cylinder connecting pin 454B. The configuration of the first biasing mechanism 455 as described above contributes to size reduction of the pin moving mechanism 4. Note that the arrangement of the coil springs 455a and 455b is not limited to the arrangement in the present embodiment. The operation of the cylinder connecting mechanism 45 will be described below.

### <Boom Connecting Mechanism>

The boom connecting mechanism 46 transitions between an extended state (see FIG. 11A) and a retracted state (see FIG. 11C) based on a rotation of the electric motor 41. The operation in which the boom connecting mechanism 46 transitions from the extended state to the retracted state is an operation of removing the boom connecting mechanism 46. The operation in which the boom connecting mechanism 46 transitions from the retracted state to the extended state is an operation of inserting the boom connecting mechanism 46.

In the extended state, the boom connecting mechanism 46 can take either an engaged state or a disengaged state with respect to a boom connecting pin (e.g., the pair of boom connecting pins 144a). The boom connecting mechanism 46 disengages the boom connecting pin from the boom by transitioning from the extended state to the retracted state while being engaged with the boom connecting pin. The boom connecting pin corresponds to an example of a second pin.

The boom connecting mechanism 46 engages the boom with the boom connecting pin by transitioning from the retracted state to the extended state while being engaged with the boom connecting pin. As illustrated in FIG. 9 and FIGS. 11A to 11C, the boom connecting mechanism 46 includes a switch gear 450, a pair of second rack bars 461a and 461b, a synchronization gear 462, and a second biasing mechanism 463. The switch gear 450 is a gear shared with the cylinder connecting mechanism 45.

The pair of second rack bars 461a and 461b are, for example, shaft members each being long in the left-right direction, and are disposed in parallel with each other while being separated from each other in the front-rear direction. Each of the pair of second rack bars 461a and 461b is disposed above the first rack bar 451 of the cylinder connecting mechanism 45.

The pair of second rack bars 461a and 461b have synchronization rack teeth portions on their respective surfaces facing each other. Each of the synchronization rack teeth portions meshes with the synchronization gear 462 (see FIGS. 11A to 11C). When the synchronization gear 462 rotates, the second rack bar 461a on one side (front side) and the second rack bar 461b on the other side (rear side) move in opposite directions in the left-right direction.

The pair of second rack bars 461a and 461b have locking claw portions 461g and 461h (see FIG. 9) at their respective distal end portions. The locking claw portions 461g and 461h are engaged with pin-side receiving portions 144c (see FIG. 9) provided in the boom connecting pins (e.g., the boom connecting pins 144a and 144b) when the boom connecting pins are moved.

The second rack bar 461a has a driving rack teeth portion 461c (see FIG. 9) on a surface facing the switch gear 450. The driving rack teeth portion 461c mesh with the teeth portion of the switch gear 450 when the switch gear 450 rotates by a predetermined amount in the second direction (a direction indicated by arrow A₂ in FIG. 9).

When the switch gear 450 rotates by the predetermined amount in the second direction from the extended state of the boom connecting mechanism 46, the driving rack teeth portion 461c and the teeth portion of the switch gear 450 mesh with each other. When the switch gear 450 further rotates in the second direction, one second rack bar 461a moves rightward based on the mesh between the driving rack teeth portion 461c and the teeth portion of the switch gear 450. When one second rack bar 461a moves rightward, the synchronization gear 462 rotates, and the other second rack bar 461b moves leftward.

The second biasing mechanism 463 returns the boom connecting mechanism 46 to the extended state when the electric motor 41 is in the non-energized state and the brake mechanism 42 is in the turn-off state in the retracted state of the boom connecting mechanism 46. The second biasing mechanism 463 biases the pair of second rack bars 461a and 461b in directions away from each other.

Specifically, the second biasing mechanism 463 includes a pair of coil springs 463a and 463b (see FIGS. 11A to 11C). The pair of coil springs 463a and 463b bias proximal end portions of the pair of second rack bars 461a and 461b toward distal ends of the pair of second rack bars 461a and 461b, respectively.

### <Operation of Connecting Mechanism>

Hereinafter, examples of operations of the cylinder connecting mechanism 45 and the boom connecting mechanism 46 will be described.

### <Operation of Cylinder Connecting Mechanism>

An example of an operation of the cylinder connecting mechanism 45 will be described with reference to FIGS. 2A to 2E and FIGS. 10A to 10C. The operation of the cylinder connecting mechanism 45 is an operation when the cylinder connecting mechanism 45 transitions from the extended state to the retracted state based on motive power from the electric motor 41, or an operation when the cylinder connecting mechanism 45 transitions from the retracted state to the extended state based on biasing force on the first biasing mechanism 455.

FIG. 10A is a schematic view illustrating the extended state of the cylinder connecting mechanism 45 and the engaged state between the pair of cylinder connecting pins 454A and 454B and the pair of cylinder pin receiving portions 141a of the distal boom 141. FIG. 10B is a schematic view illustrating a state in the middle of transition of the cylinder connecting mechanism 45 from the extended state to the retracted state. Further, FIG. 10C is a schematic view illustrating the retracted state of the cylinder connecting mechanism 45 and the disengaged state between the pair of cylinder connecting pins 454A and 454B and the pair of cylinder pin receiving portions 141a of the distal boom 141.

The extended state of the cylinder connecting mechanism 45 illustrated in FIG. 10A corresponds to the state of the cylinder connecting mechanism 45 in FIGS. 2A to 2D. The state of the cylinder connecting mechanism 45 illustrated in FIG. 10B corresponds to a state in the middle of transition from the state of the cylinder connecting mechanism 45 illustrated in FIG. 2D to the state of the cylinder connecting mechanism 45 illustrated in FIG. 2E. The retracted state of the cylinder connecting mechanism 45 illustrated in FIG. 10C corresponds to the state of the cylinder connecting mechanism 45 illustrated in FIG. 2E.

When the cylinder connecting mechanism 45 transitions from the extended state to the retracted state, the control unit 530 (see FIGS. 10A to 11C) drives the electric motor 41. The motive power from the electric motor 41 is transmitted to the pair of cylinder connecting pins 454A and 454B through a first transmission path and a second transmission path to be described below. Note that the control unit 530 may have a configuration in which a CPU, a ROM, a RAM, an HDD, and the like are substantially connected to each other by a bus, or a configuration including a one-chip LSI or the like.

The first transmission path is a path through which the motive power from the electric motor 41 is transmitted in the following order.
(First transmission path) switch gear 450→first rack bar 451→first gear mechanism 452→right cylinder connecting pin 454A

The second transmission path is a path through which the motive power from the electric motor 41 is transmitted in the following order.
(Second transmission path) switch gear 450→first rack bar 451→second gear mechanism 453→left cylinder connecting pin 454B

Specifically, first, in the first transmission path and the second transmission path, the switch gear 450 rotates in the first direction (the direction indicated by arrow A₁ in FIG. 10A) based on the motive power from the electric motor 41. At this time, the lower transmission shaft 432b of the vertical transmission mechanism 432 rotates in the first direction together with the switch gear 450.

In the first transmission path, when the switch gear 450 rotates in the first direction, the first rack bar 451 moves rightward in accordance with the rotation. In the first transmission path, when the first rack bar 451 moves rightward, the right cylinder connecting pin 454A moves leftward via the first gear mechanism 452. On the other hand, in the second transmission path, when the first rack bar 451 moves rightward, the left cylinder connecting pin 454B moves rightward via the second gear mechanism 453.

The position information detection device 5 to be described below detects that the pair of cylinder connecting pins 454A and 454B are disengaged from the pair of cylinder pin receiving portions 141a of the distal boom 141 and moved to predetermined positions (e.g., the positions illustrated in FIG. 10C). Then, based on the detection result, the control unit 530 (see FIGS. 10A to 11C) turns off the electric motor 41 while turning on the brake mechanism 42 to stop the operation of the cylinder connecting mechanism 45.

The transition of the cylinder connecting mechanism 45 from the retracted state to the extended state is automatically performed based on the biasing force of the first biasing mechanism 455 when the brake mechanism 42 is turned off in the non-energized state of the electric motor 41.

### <Operation of Boom Connecting Mechanism>

Next, an example of an operation of the above-described boom connecting mechanism 46 will be described with reference to FIGS. 2A to 2E and FIGS. 11A to 11C.

FIG. 11A is a schematic view illustrating the extended state of the boom connecting mechanism 46 and the engaged state between the pair of boom connecting pins 144a and the pair of first boom pin receiving portions 142b of the intermediate boom 142. FIG. 11B is a schematic view illustrating a state in the middle of state transition of the boom connecting mechanism 46 from the extended state to the retracted state. FIG. 11C is a schematic view illustrating the retracted state of the boom connecting mechanism 46 and the disengaged state between the pair of boom connecting pins 144a and the pair of first boom pin receiving portions 142b of the intermediate boom 142.

The extended state of the boom connecting mechanism 46 illustrated in FIG. 11A corresponds to the state of the boom connecting mechanism 46 in FIG. 2A. The state of the boom connecting mechanism 46 illustrated in FIG. 11B corresponds to a state in the middle of transition from the state of the boom connecting mechanism 46 illustrated in FIG. 2A to the state of the boom connecting mechanism 46 illustrated in FIG. 2B. The retracted state of the boom connecting mechanism 46 illustrated in FIG. 11C corresponds to the state of the boom connecting mechanism 46 illustrated in FIG. 2B.

The boom connecting mechanism 46 transitions between the extended state and the retracted state based on motive power from the electric motor 41. Here, the position of the switch gear 450 illustrated in FIG. 11A is defined as a reference position of the switch gear 450.

When the boom connecting mechanism 46 transitions from the extended state to the retracted state, the control unit 530 (see FIGS. 10A to 11C) drives the electric motor 41 in a direction opposite to a direction in which the cylinder connecting mechanism 45 is operated. The motive power from the electric motor 41 is transmitted through the following path.
(Transmission path) switch gear 450→one second rack bar 461a→synchronization gear 462→the other second rack bar 461b

First, in the transmission path, the switch gear 450 rotates in the second direction (the direction indicated by arrow A₂ in FIG. 11A) of the rotation direction of the switch gear 450 based on the motive power from the electric motor 41. At this time, the lower transmission shaft 432b of the vertical transmission mechanism 432 rotates in the second direction together with the switch gear 450. When the switch gear 450 rotates in the second direction, one second rack bar 461a moves rightward in accordance with the rotation.

Then, the synchronization gear 462 rotates in accordance with the rightward movement of one second rack bar 461a. Then, the other second rack bar 461b moves leftward in accordance with the rotation of the synchronization gear 462.

When the state transitions from the extended state to the retracted state while the pair of second rack bars 461a and 461b are engaged with the pair of boom connecting pins 144a, the pair of boom connecting pins 144a are disengaged from the pair of first boom pin receiving portions 142b of the intermediate boom 142 (see FIG. 11C).

The position information detection device 5 to be described below detects that the pair of boom connecting pins 144a are disengaged from the pair of first boom pin receiving portions 142b of the intermediate boom 142 and moved to predetermined positions (e.g., the positions illustrated in FIG. 11C). Then, based on the detection result, the control unit 530 turns off the electric motor 41 while turning on the brake mechanism 42 to stop the operation of the boom connecting mechanism 46.

When the brake mechanism 42 is turned off in the non-energized state of the electric motor 41, the operation of inserting the boom connecting mechanism 46 is automatically performed based on the biasing force of the second biasing mechanism 463. During this state transition, the pair of boom connecting pins 144a move in directions away from each other.

The position information detection device 5 to be described below detects that the pair of boom connecting pins 144a are engaged with the pair of first boom pin receiving portions 142b of the intermediate boom 142 and moved to predetermined positions (e.g., the positions illustrated in FIG. 11A). The detection result is used to control the next operation of the actuator 2.

The position information detection device 5 detects information on the positions of the pair of cylinder connecting pins 454A and 454B and the pair of boom connecting pins 144a and 144b.

First, a configuration of the position information detection device 5 will be described. The position information detection device 5 includes a support 50, a first detection device 51, a second detection device 52, and a cover member 54.

The first detection device 51 and the second detection device 52 are supported on the trunnion 40 by a support 50. The first detection device 51 and the second detection device 52 detect information on the positions of the pair of cylinder connecting pins 454A and 454B and the pair of boom connecting pins 144a and 144b by different detection methods.

At a normal time, only one of the first detection device 51 and the second detection device 52 detects the information on the positions of the pair of cylinder connecting pins 454A and 454B and the pair of boom connecting pins 144a and 144b. Then, for example, when the control unit 530 (see FIGS. 10A to 11C) detects a failure of the one detection device, the other one of the first detection device 51 and the second detection device 52 detects information on the positions of the pair of cylinder connecting pins 454A and 454B and the pair of boom connecting pins 144a and 144b.

Preferably, the one detection device is the second detection device 52, and the other detection device is the first detection device 51. However, the one detection device may be the first detection device 51, and the other detection device may be the second detection device 52. Alternatively, at a normal time, the first detection device 51 and the second detection device 52 may detect the information on the positions of the pair of cylinder connecting pins 454A and 454B and the pair of boom connecting pins 144a and 144b.

Note that each of the first detection device 51 and the second detection device 52 cannot detect its failure by itself. Therefore, when there is a contradiction (e.g., a deviation of a predetermined value or more) between a detection value of the first detection device 51 and a detection value of the second detection device 52, the control unit 530 may determine that a failure has occurred in at least one of the first detection device 51 and the second detection device 52.

Alternatively, in a normal control, the control unit 530 may determine a failure of a detection device based on the detection values of the first detection device 51 and the second detection device 52 while detecting information on the positions of the pair of cylinder connecting pins 454A and 454B and the pair of boom connecting pins 144a and 144b based on the detection value of the second detection device 52.

At this time, the control unit 530 does not detect information on the positions of the pair of cylinder connecting pins 454A and 454B and the pair of boom connecting pins 144a and 144b based on the detection value of the first detection device 51. Alternatively, when an occurrence of a failure in the second detection device 52 can be specified by a failure determination, the control unit 530 may detect the information on the positions of the pair of cylinder connecting pins 454A and 454B and the pair of boom connecting pins 144a and 144b based on the detection value of the first detection device 51.

The support 50 is a member that supports the first detection device 51 and the second detection device 52 on the trunnion 40. The support 50 is fixed to the trunnion 40. Specifically, the support 50 is fixed to a rear side surface (a side surface on the negative side of the X direction) of the trunnion 40.

The support 50 includes a right side plate 501, a left side plate 502, a rear side plate 503, a right side fixing plate 504, and a left side fixing plate 505. The right side plate 501 has a shape like a plate parallel to the X-Z plane. The left side plate 502 has a shape like a plate parallel to the X-Z plane. The right side plate 501 and the left side plate 502 are separated from each other in the left-right direction (Y direction) and face each other. Each of the right side plate 501 and the left side plate 502 corresponds to an example of a first plate portion.

The rear side plate 503 corresponds to an example of a second plate portion, and has a shape like a plate parallel to the Y-Z plane. The rear side plate 503 connects a rear end portion (an end portion on the negative side of the X direction) of the right side plate 501 and a rear end portion (an end portion on the negative side of the X direction) of the left side plate 502 in the left-right direction. That is, the support 50 is a U-shaped and plate-shaped member that is open in the up-down direction and open forward. A space surrounded by the right side plate 501, the left side plate 502, and the rear side plate 503 of the support 50 is an accommodation space 506. The accommodation space 506 may be regarded as a space defined by the support 50.

The right side fixing plate 504 has a shape like a plate parallel to the Y-Z plane. The right side fixing plate 504 is fixed to a front end portion of the right side plate 501.

The left side fixing plate 505 has a shape like a plate parallel to the Y-Z plane. The left side fixing plate 505 is fixed to a front end portion of the left side plate 502.

The front end portions of the support 50 (the front end portions of the right side plate and the left side plate) are fixed to a rear side surface of the trunnion 40 via the right side fixing plate 504 and the left side fixing plate 505. In this state, each of the right side fixing plate 504 and the left side fixing plate 505 is positioned with respect to the trunnion 40 by a positioning pin 507 inserted into a fixed portion 400 on the trunnion side. Such a configuration contributes to improvement of assembling work efficiency when the support 50 is assembled to the trunnion 40.

The lower transmission shaft 432b is disposed between the right side plate 501 and the left side plate 502 of the support 50. That is, the lower transmission shaft 432b is disposed in the accommodation space 506. The right side plate 501 and the left side plate 502 are parallel to the lower transmission shaft 432b.

The first detection device 51 includes a first detection object 510, a second detection object 511, a first sensor 512, a second sensor 513, and a third sensor 514. The first detection device 51 detects information on the positions of the pair of cylinder connecting pins 454A and 454B and the pair of boom connecting pins 144a and 144b based on a combination of outputs (detection values) of the first sensor 512, the second sensor 513, and the third sensor 514.

The first detection object 510 is fixed to the lower transmission shaft 432b in a state where the lower transmission shaft 432b is inserted into a center hole thereof. That is, the first detection object 510 is disposed in the accommodation space 506. The first detection object 510 rotates together with the lower transmission shaft 432b. The first detection object 510 has a first cylindrical surface 510a and a first flat surface 510b on an outer peripheral surface thereof.

The first cylindrical surface 510a corresponds to an example of a first detection surface of the first detection object. The first cylindrical surface 510a is a cylindrical surface having a predetermined outer diameter and provided on a partial portion (also referred to as a first portion) of the outer peripheral surface of the first detection object 510. The first flat surface 510b corresponds to an example of a second detection surface of the first detection object. The first flat surface 510b is a flat surface provided on the other portion (also referred to as a second portion) of the outer peripheral surface of the first detection object 510. The shapes of the first detection surface of the first detection object and the second detection surface of the first detection object are not limited to the shapes in the present embodiment. It is only required that the shapes of the first detection surface of the first detection object and the second detection surface of the first detection object are shapes that can be distinguished from each other (that is, different shapes).

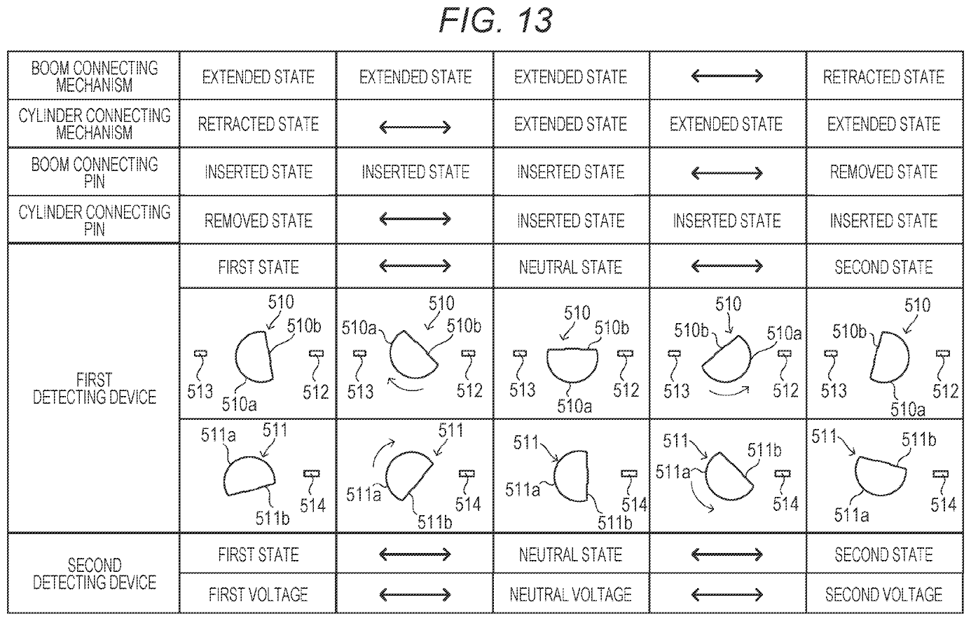

As illustrated in FIG. 13, in a neutral state of the first detection object 510, the first cylindrical surface 510a is disposed in a lower half portion, and the first flat surface 510b is disposed in an upper half portion. The neutral state of the first detection object 510 corresponds to the inserted state of the pair of cylinder connecting pins 454A and 454B and the boom connecting pins 144a (see FIGS. 2A to 2E).

The second detection object 511 is fixed to the lower transmission shaft 432b in a state where the lower transmission shaft 432b is inserted into a center hole thereof. That is, the second detection object 511 is disposed in the accommodation space 506. The second detection object 511 rotates together with the lower transmission shaft 432b. The second detection object 511 is disposed in front of the first detection object 510. The second detection object 511 has a second cylindrical surface 511a and a second flat surface 511b on an outer peripheral surface thereof.

The second cylindrical surface 511a corresponds to an example of a first detection surface of the second detection object. The second cylindrical surface 511a is a cylindrical surface having a predetermined outer diameter and provided on a partial portion (also referred to as a first portion) of the outer peripheral surface of the second detection object 511. The second flat surface 511b corresponds to an example of a second detection surface of the second detection object. The second flat surface 511b is a flat surface provided on the other portion (also referred to as a second portion) of the outer peripheral surface of the second detection object 511. The shapes of the first detection surface of the second detection object and the second detection surface of the second detection object are not limited to the shapes in the present embodiment. It is only required that the shapes of the first detection surface of the second detection object and the second detection surface of the second detection object are shapes that can be distinguished from each other (that is, different shapes).

As illustrated in FIG. 13, in the neutral state of the second detection object 511, the second cylindrical surface 511a is disposed in a left half portion, and the second flat surface 511b is disposed in a right half portion. The neutral state of the second detection object 511 corresponds to the inserted state of the pair of cylinder connecting pins 454A and 454B and the boom connecting pins 144a (see FIGS. 2A to 2E). The neutral state of the second detection object 511 corresponds to the extended state of the cylinder connecting mechanism 45 and the extended state of the boom connecting mechanism 46 as illustrated in FIGS. 10A and 11A.

Each of the first sensor 512, the second sensor 513, and the third sensor 514 corresponds to an example of a first detection unit, and is a non-contact proximity sensor. Each of the first sensor 512, the second sensor 513, and the third sensor 514 is supported by the support 50.

Specifically, the first sensor 512 is supported by the right side plate 501 of the support 50. A distal end portion of the first sensor 512 faces the outer peripheral surface of the first detection object 510 in the left-right direction. The first sensor 512 outputs an electric signal corresponding to a distance from the outer peripheral surface of the first detection object 510.

For example, the output of the first sensor 512 is turned on while facing the first cylindrical surface 510a of the first detection object 510. On the other hand, the output of the first sensor 512 is turned off while facing the first flat surface 510b of the first detection object 510.

The second sensor 513 is supported by the left side plate 502 of the support 50. A distal end portion of the second sensor 513 faces the outer peripheral surface of the first detection object 510 in the left-right direction. The first sensor 512 and the second sensor 513 face each other in the left-right direction. The second sensor 513 outputs an electric signal corresponding to a distance from the outer peripheral surface of the first detection object 510.

For example, the output of the second sensor 513 is turned on while facing the first cylindrical surface 510a of the first detection object 510. On the other hand, the output of the second sensor 513 is turned off while facing the first flat surface 510b of the first detection object 510.

The third sensor 514 is supported by the right side plate 501 of the support 50. The third sensor 514 is disposed in front of the first sensor 512 on the right side plate 501 of the support 50. A distal end portion of the third sensor 514 faces the outer peripheral surface of the second detection object 511 in the left-right direction. The third sensor 514 outputs an electric signal corresponding to a distance from the outer peripheral surface of the second detection object 511. The third sensor 514 may be supported by the left side plate 502 of the support 50. The position of the third sensor 514 is not limited to the illustrated position.

For example, the output of the third sensor 514 is turned on while facing the second cylindrical surface 511a of the second detection object 511. On the other hand, the output of the third sensor 514 is turned off while facing the second flat surface 511b of the second detection object 511.

The second detection device 52 is a non-contact potentiometer, and includes a detection object 520 and a sensor 521. The detection object 520 is a magnet, and is fixed to the lower transmission shaft 432b in a state where a rear end portion of the lower transmission shaft 432b is inserted into a center hole thereof. Accordingly, the detection object 520 rotates together with the lower transmission shaft 432b. The detection object 520 is disposed behind the first detection object 510 of the first detection device 51.

The sensor 521 corresponds to an example of a second detection unit, has a Hall element, and is supported by the rear side plate 503 of the support 50.

As described above, in the present embodiment, the first sensor 512, the second sensor 513, and the third sensor 514 of the first detection device 51, and the sensor 521 of the second detection device 52 are supported by the support 50. In other words, the support 50 unitizes the first sensor 512, the second sensor 513, and the third sensor 514 of the first detection device 51, and the sensor 521 of the second detection device 52. Therefore, by removing the support 50 from the trunnion 40, the sensors 512, 513, 514, and 521 can be collectively removed from the trunnion 40. Such a configuration contributes to improvement of assembly work efficiency and improvement of maintenance work efficiency.

The detection surfaces of the sensors 512, 513, 514, and 521 are disposed in the accommodation space 506 surrounded by the support 50. Such a configuration is capable of suppressing damage to the detection surfaces of the sensors 512, 513, 514, and 521.

The sensor 521 faces the detection object 520 in the front-rear direction. The sensor 521 outputs a voltage corresponding to a phase of the detection object 520. That is, the sensor 521 outputs a voltage corresponding to a rotation angle of the lower transmission shaft 432b to which the detection object 520 is fixed.

In the present embodiment, a method (detection method) in which the first detection device 51 detects information regarding a position is different from a method (detection method) in which the second detection device 52 detects information regarding a position. That is, the pin moving mechanism 4 according to the present embodiment includes two detection mechanisms having different detection methods for detecting information on the positions of the pair of cylinder connecting pins 454A and 454B and the pair of boom connecting pins 144a and 144b. The second detection device may be a contact potentiometer or an encoder.

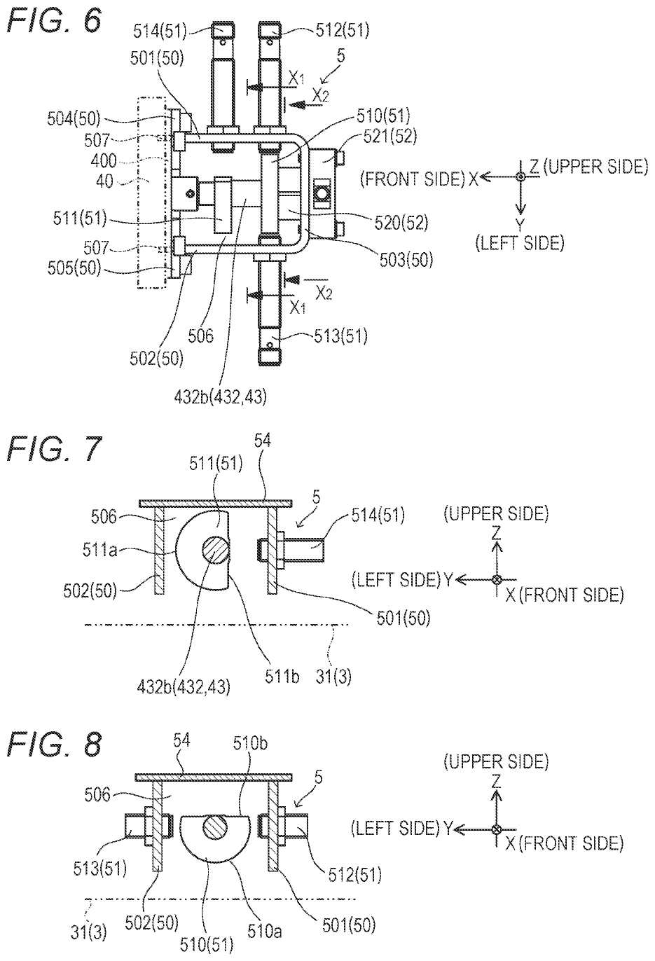

The cover member 54 is, for example, a plate member having a rectangular shape and parallel to the X-Y plane. As illustrated in FIGS. 7 and 8, the cover member 54 covers an upper opening of the support 50 from above. In FIG. 6, the cover member 54 is omitted.

The cover member 54 is fixed to an upper end portion of the support 50 or the trunnion 40. Such a cover member 54 suppresses intrusion of foreign matter into the accommodation space 506 from the upper opening of the support 50. Furthermore, as illustrated in FIGS. 7 and 8, a lower opening of the support 50 faces a surface of the telescopic cylinder 3 (specifically, the rod member 31) with a predetermined distance therebetween. Such a configuration suppresses intrusion of foreign matter into the accommodation space 506 from the lower opening of the support 50.

For example, if foreign matter adheres to the detection surfaces of the first sensor 512, the second sensor 513, and the third sensor 514 of the first detection device 51, an erroneous detection may occur in each of the sensors 512, 513, and 514, and the reliability of the detection result may be reduced. In the present embodiment, since the intrusion of the foreign matter into the accommodation space 506 from the upper and lower openings of the support 50 is suppressed, the reliability of the detection results of the first detection device 51 and the second detection device 52 can be secured.

In addition, since the lower opening of the accommodation space 506 faces the surface of the telescopic cylinder 3, even if the first detection object 510 and the second detection object 511 of the first detection device 51 or the detection object 520 of the second detection device 52 fall off from the lower transmission shaft 432b, it is possible to suppress falling of each of the detection objects 510, 511, and 520 downward.

In the position information detection device 5 as described above, at a normal time, the second detection device 52 detects information on the positions of the pair of cylinder connecting pins 454A and 454B and the boom connecting pins 144a. When the control unit detects a failure of the second detection device 52, the first detection device 51 detects information on the positions of the pair of cylinder connecting pins 454A and 454B and the boom connecting pins 144a. However, the first detection device 51 and the second detection device 52 may detect information on the positions of the pair of cylinder connecting pins 454A and 454B and the boom connecting pins 144a from the normal time.

Here, the operation of the position information detection device 5 will be described with reference to FIGS. 12 and 13. FIG. 12 is a timing chart at the time of the operation of extending the distal boom 141 in the telescopic boom 14. FIG. 13 is a view illustrating a relationship between the states of the pair of cylinder connecting pins 454A and 454B and the boom connecting pins 144a and the states of the first detection device 51 and the second detection device 52.

Hereinafter, only the operation of extending the distal boom 141 in the telescopic boom 14 will be described. The operation of retracting the distal boom 141 is performed in an order reverse to the following order of the telescoping operation.

In the following description, the state transition between the extended state and the retracted state of the cylinder connecting mechanism 45 and the boom connecting mechanism 46 is as described above. Therefore, the detailed description of the state transition of the cylinder connecting mechanism 45 and the boom connecting mechanism 46 will be omitted.

In addition, the control unit (not illustrated) controls the electric motor 41 to be switched on/off and controls the brake mechanism 42 to be switched on/off based on the output of the position information detection device 5.

FIG. 2A illustrates a retracted state of the telescopic boom 14. In this state, the distal boom 141 is connected to the intermediate boom 142 via the boom connecting pins 144a. Therefore, the distal boom 141 cannot be displaced with respect to the intermediate boom 142 in the longitudinal direction (the left-right direction in FIGS. 2A to 2E).

In FIG. 2A, the distal end portions of the pair of cylinder connecting pins 454A and 454B are engaged with the pair of cylinder pin receiving portions 141a of the distal boom 141. That is, the distal boom 141 and the cylinder member 32 are in a connected state.

In the state of FIG. 2A, the state of each member is as follows (see T₀ to T₁ in FIG. 12).
Brake mechanism 42: OFF
Electric motor 41: OFF
Cylinder connecting mechanism 45: extended state
Boom connecting mechanism 46: extended state
Cylinder connecting pins 454A and 454B: inserted state
Boom connecting pins 144a: inserted state

In the state illustrated in FIG. 2A, the first detection device 51 and the second detection device 52 of the position information detection device 5 are in the neutral state as illustrated in FIG. 13.

In the neutral state of the first detection device 51, the first sensor 512 and the second sensor 513 face the first cylindrical surface 510a of the first detection object 510. Therefore, the outputs of the first sensor 512 and the second sensor 513 are turned on. On the other hand, in the neutral state of the first detection device 51, the third sensor 514 faces the second flat surface 511b of the second detection object 511. Therefore, the output of the third sensor 514 is turned off.

When the outputs of the first sensor 512 and the second sensor 513 are turned on and the output of the third sensor 514 is turned off, the first detection device 51 detects that the pair of cylinder connecting pins 454A and 454B are in the inserted state and the boom connecting pins 144a are in the inserted state. In the neutral state of the first detection device 51, the switch gear 450 is located at the reference position illustrated in FIGS. 10A and 11A.

In the neutral state of the second detection device 52, the rotation angle of the detection object 520 is 0 degrees. The sensor 521 is configured to, in the neutral state of the second detection device 52, output a predetermined voltage (hereinafter referred to as a neutral voltage) corresponding to the neutral state. In the neutral state of the second detection device 52, the switch gear 450 is located at the reference position illustrated in FIGS. 10A and 11A.

When the output of the sensor 521 is a neutral voltage, the second detection device 52 detects that the pair of cylinder connecting pins 454A and 454B are in the inserted state and the boom connecting pins 144a are in the inserted state.

Next, in the state illustrated in FIG. 2A, the electric motor 41 is rotated normally (rotated in the direction indicated by arrow A₂ in FIG. 11A), and the pair of boom connecting pins 144a are displaced in such a direction to be disengaged from the pair of first boom pin receiving portions 142b of the intermediate boom 142 by the boom connecting mechanism 46 of the actuator 2. At this time, the boom connecting mechanism 46 transitions from the extended state to the retracted state.

At the time of transition from the state of FIG. 2A to the state of FIG. 2B, the state of each member is as follows (see T₁ to T₂ in FIG. 12).

Brake mechanism 42: OFF
Electric motor 41: ON (normal rotation)
Cylinder connecting mechanism 45: extended state
Boom connecting mechanism 46: extended state→retracted state
Cylinder connecting pins 454A and 454B: inserted state
Boom connecting pins 144a: inserted state→removed state

When the boom connecting pins 144a transition from the inserted state to the removed state, the first detection device 51 and the second detection device 52 of the position information detection device 5 transition from the neutral state to the second state in accordance with the rotation of the lower transmission shaft 432b as illustrated in FIG. 13.

When the state of the first detection device 51 transitions from the neutral state to the second state, the first sensor 512 faces the first cylindrical surface 510a of the first detection object 510. Therefore, the output of the first sensor 512 is turned on. On the other hand, the second sensor 513 faces the first flat surface 510b of the first detection object 510. Therefore, the output of the second sensor 513 is turned off.

When the state of the first detection device 51 transitions from the neutral state to the second state, the third sensor 514 faces the second flat surface 511b of the second detection object 511. Therefore, the output of the third sensor 514 is turned off.

In this manner, when the output of the first sensor 512 is turned on, the output of the second sensor 513 is turned off, and the output of the third sensor 514 is turned off, the first detection device 51 detects that the boom connecting pins 144a transition from the inserted state to the removed state.

When the boom connecting pins 144a are in the removed state, the first detection device 51 is in the second state. Conversely, when the first detection device 51 is in the second state, the boom connecting pins 144a are in the removed state (the state illustrated in FIG. 2B).

In the second state of the first detection device 51, the first sensor 512 faces the first cylindrical surface 510a of the first detection object 510. Therefore, the output of the first sensor 512 is turned on. On the other hand, in the second state of the first detection device 51, the second sensor 513 faces the first flat surface 510b of the first detection object 510. Therefore, the output of the second sensor 513 is turned off.

In the second state of the first detection device 51, the third sensor 514 faces the second cylindrical surface 511a of the second detection object 511. Therefore, the output of the third sensor 514 is turned on.

In this manner, when the output of the first sensor 512 is turned on, the output of the second sensor 513 is turned off, and the output of the third sensor 514 is turned on, the first detection device 51 detects that the boom connecting pins 144a are in the removed state.

When the state of the second detection device 52 transitions from the neutral state to the second state, the output of the sensor 521 changes depending on the phase of the detection object 520. Here, the sensor 521 is configured to output a predetermined voltage (hereinafter referred to as a second voltage) corresponding to the second state. Therefore, when the state of the second detection device 52 transitions from the neutral state to the second state, the output of the sensor 521 changes from the neutral voltage to the second voltage. When the output of the sensor 521 changes from the neutral voltage toward the second voltage, the second detection device 52 detects that the boom connecting pins 144a transition from the inserted state to the removed state.

When the boom connecting pins 144a are in the removed state, the second detection device 52 is in the second state. Conversely, when the second detection device 52 is in the second state, the boom connecting pins 144a are in the removed state. In the second state of the second detection device 52, the output of the sensor 521 is the second voltage. When the output of the sensor 521 is the second voltage, the second detection device 52 detects that the boom connecting pins 144a are in the removed state.

When the boom connecting pins 144a are in the removed state, the engagement between the pair of boom connecting pins 144a and the pair of first boom pin receiving portions 142b of the intermediate boom 142 is released (see FIG. 2B). When the first detection device 51 and/or the second detection device 52 detects that the boom connecting pins 144a are in the removed state, the control unit turns off the electric motor 41 while turning on the brake mechanism 42 to stop the operation of the boom connecting mechanism 46.

The timing at which the electric motor 41 is turned off and the timing at which the brake mechanism 42 is turned on are appropriately controlled by the control unit. For example, although not illustrated, the electric motor 41 is turned off after the brake mechanism 42 is turned on.

In the state of FIG. 2B, the state of each member is as follows (see T₂ in FIG. 12).
Brake mechanism 42: ON
Electric motor 41: OFF
Cylinder connecting mechanism 45: extended state
Boom connecting mechanism 46: retracted state
Cylinder connecting pins 454A and 454B: inserted state
Boom connecting pins 144a: removed state

Next, in the state illustrated in FIG. 2B, pressurized oil is supplied to a hydraulic chamber on the extension side in the telescopic cylinder 3 of the actuator 2. Then, the cylinder member 32 is displaced in the extension direction (the left side in FIGS. 2A to 2E).

Together with the displacement of the cylinder member 32 as described above, the distal boom 141 is displaced in the extension direction (see FIG. 2C). At this time, the state of each unit at T₂ in FIG. 12 is maintained until T₃ in FIG. 12.

Next, the brake mechanism 42 is released in the state illustrated in FIG. 2C. Then, based on the biasing force of the second biasing mechanism 463, the boom connecting mechanism 46 displaces the pair of boom connecting pins 144a in such a direction as to engage with the pair of second boom pin receiving portions 142c of the intermediate boom 142. At this time, the state of the boom connecting mechanism 46 transitions (that is, automatically returns) from the retracted state to the extended state.

At the time of transition from the state of FIG. 2C to FIG. 2D, the state of each member is as follows (see T₃ to T₄ in FIG. 12).
Brake mechanism 42: OFF
Electric motor 41: OFF
Cylinder connecting mechanism 45: extended state
Boom connecting mechanism 46: retracted state→extended state
Cylinder connecting pins 454A and 454B: inserted state
Boom connecting pins 144a: removed state→inserted state

When the boom connecting pins 144a transition from the removed state to the inserted state, the first detection device 51 and the second detection device 52 of the position information detection device 5 transition from the second state to the neutral state in accordance with the rotation of the lower transmission shaft 432b as illustrated in FIG. 13.

When the state of the first detection device 51 transitions from the second state to the neutral state, the first sensor 512 faces the first cylindrical surface 510a of the first detection object 510. Therefore, the output of the first sensor 512 is turned on. On the other hand, the second sensor 513 faces the first flat surface 510b of the first detection object 510. Therefore, the output of the second sensor 513 is turned off.

When the state of the first detection device 51 transitions from the second state to the neutral state, the third sensor 514 faces the second flat surface 511b of the second detection object 511. Therefore, the output of the third sensor 514 is turned off.

When the boom connecting pin 144a is in the inserted state, the first detection device 51 is in the neutral state. Conversely, when the first detection device 51 is in the neutral state, the boom connecting pins 144a are in the inserted state (the state illustrated in FIG. 2D). The states of the first sensor 512, the second sensor 513, and the third sensor 514 in the neutral state of the first detection device 51 are as described above.

In this manner, when the output of the first sensor 512 is turned on, the output of the second sensor 513 is turned on, and the output of the third sensor 514 is turned off, the first detection device 51 detects that the boom connecting pins 144a are in the neutral state.

In addition, when the state of the second detection device 52 transitions from the second state to the neutral state, the output of the sensor 521 changes from the second voltage to the neutral voltage according to the phase of the detection object 520. When the output of the sensor 521 changes from the second voltage toward the neutral voltage, the second detection device 52 detects that the boom connecting pins 144a transition from the removed state to the inserted state.

When the boom connecting pins 144a are in the inserted state, the second detection device 52 is in the neutral state. In the neutral state of the second detection device 52, the output of the sensor 521 is the neutral voltage. When the output of the sensor 521 is the neutral voltage, the second detection device 52 detects that the boom connecting pins 144a are in the inserted state.

In this state, as illustrated in FIG. 2D, the pair of boom connecting pins 144a are engaged with the pair of second boom pin receiving portions 142c of the intermediate boom 142.

In the state illustrated in FIG. 2D, the state of each member is as follows (see T₄ in FIG. 12).
Brake mechanism 42: OFF
Electric motor 41: OFF
Cylinder connecting mechanism 45: extended state
Boom connecting mechanism 46: extended state
Cylinder connecting pins 454A and 454B: inserted state
Boom connecting pins 144a: inserted state

Furthermore, in the state illustrated in FIG. 2D, the electric motor 41 is rotated reversely (rotated in the direction indicated by arrow A₁ in FIG. 10A), and the pair of cylinder connecting pins 454A and 454B are displaced in such a direction to be disengaged from the pair of cylinder pin receiving portions 141a of the distal boom 141 by the cylinder connecting mechanism 45. At this time, the cylinder connecting mechanism 45 transitions from the extended state to the retracted state.

At the time of transition from the state of FIG. 2D to the state of FIG. 2E, the state of each member is as follows (see T₅ to T₆ in FIG. 12).
Brake mechanism 42: OFF
Electric motor 41: ON (reverse rotation)
Cylinder connecting mechanism 45: extended state→retracted state
Boom connecting mechanism 46: extended state
Cylinder connecting pins 454A and 454B: inserted state→removed state
Boom connecting pins 144a: inserted state

When the pair of cylinder connecting pins 454A and 454B transition from the inserted state to the removed state, the first detection device 51 and the second detection device 52 of the position information detection device 5 transition from the neutral state to the first state in accordance with the rotation of the lower transmission shaft 432b as illustrated in FIG. 13.

When the first detection device 51 transitions from the neutral state to the first state, the first sensor 512 faces the first flat surface 510b of the first detection object 510. Therefore, the output of the first sensor 512 is turned off. On the other hand, the second sensor 513 faces the first cylindrical surface 510a of the first detection object 510. Therefore, the output of the second sensor 513 is turned on.

When the state of the first detection device 51 transitions from the neutral state to the first state, the third sensor 514 faces the second flat surface 511b of the second detection object 511. Therefore, the output of the third sensor 514 is turned off.

In this manner, when the output of the first sensor 512 is turned off, the output of the second sensor 513 is turned on, and the output of the third sensor 514 is turned off, the first detection device 51 detects that the pair of cylinder connecting pins 454A and 454B transition from the inserted state to the removed state.

When the pair of cylinder connecting pins 454A and 454B are in the removed state, the first detection device 51 is in the first state. Conversely, when the first detection device 51 is in the first state, the pair of cylinder connecting pins 454A and 454B are in the removed state (state illustrated in FIG. 2E).

In the first state of the first detection device 51, the first sensor 512 faces the first flat surface 510b of the first detection object 510. Therefore, the output of the first sensor 512 is turned off. On the other hand, in the first state of the first detection device 51, the second sensor 513 faces the first cylindrical surface 510a of the first detection object 510. Therefore, the output of the second sensor 513 is turned on.

In the first state of the first detection device 51, the third sensor 514 faces the second cylindrical surface 511a of the second detection object 511. Therefore, the output of the third sensor 514 is turned on.

In this manner, when the output of the first sensor 512 is turned off, the output of the second sensor 513 is turned on, and the output of the third sensor 514 is turned on, the first detection device 51 detects that the pair of cylinder connecting pins 454A and 454B are in the removed state.

When the state of the second detection device 52 transitions from the neutral state to the first state, the output of the sensor 521 changes depending on the phase of the detection object 520. Here, the sensor 521 is configured to output a predetermined voltage (hereinafter referred to as a first voltage) corresponding to the first state.

Therefore, when the state of the second detection device 52 transitions from the neutral state to the first state, the output of the sensor 521 changes from the neutral voltage to the first voltage. When the output of the sensor 521 changes from the neutral voltage toward the first voltage, the second detection device 52 detects that the pair of cylinder connecting pins 454A and 454B transitions from the inserted state to the removed state.

When the pair of cylinder connecting pins 454A and 454B are in the removed state, the second detection device 52 is in the first state. In the first state of the second detection device 52, the output of the sensor 521 is the first voltage. When the output of the sensor 521 is the first voltage, the second detection device 52 detects that the pair of cylinder connecting pins 454A and 454B are in the removed state.

When the cylinder connecting pins 454A and 454B are in the removed state, the engagement between the distal end portions of the pair of cylinder connecting pins 454A and 454B and the pair of cylinder pin receiving portions 141a of the distal boom 141 is released as illustrated in FIG. 2E. When the first detection device 51 and/or the second detection device 52 detects that the pair of cylinder connecting pins 454A and 454B are in the removed state, the control unit turns off the electric motor 41 while turning on the brake mechanism 42 to stop the operation of the cylinder connecting mechanism 45.

In the state illustrated in FIG. 2E, the state of each member is as follows (see T₆ in FIG. 12).
Brake mechanism 42: ON
Electric motor 41: OFF
Cylinder connecting mechanism 45: retracted state
Boom connecting mechanism 46: extended state
Cylinder connecting pins 454A and 454B: removed state
Boom connecting pins 144a: inserted state

Thereafter, although not illustrated, when pressure oil is supplied to a hydraulic chamber on the retraction side in the telescopic cylinder 3 of the actuator 2, the cylinder member 32 is displaced in the retraction direction (the right side in FIGS. 2A to 2E). At this time, since the distal boom 141 and the cylinder member 32 are in the disconnected state, the cylinder member 32 is displaced alone in the retraction direction. When the intermediate boom 142 is extended, the operations of FIGS. 2A to 2E are performed on the intermediate boom 142.

### Effect and Advantage of Present Embodiment

In the mobile crane 1 according to the present embodiment having the above-described configuration, the positions of the pair of cylinder connecting pins 454A and 454B and the boom connecting pins 144a and 144b are detected by the above-described position information detection device 5. Therefore, the telescoping operation of the telescopic boom 14 can be accurately controlled.

In particular, in the present embodiment, the first detection device 51 and the second detection device 52, which are different in detection method, are included in the position information detection device 5. Then, the second detection device 52 detects information on positions at a normal time, and, the first detection device 51 detects information on positions in a case where the second detection device 52 fails. Therefore, even in a case where any one of the first detection device 51 and the second detection device 52 fails, the positions of the pair of cylinder connecting pins 454A and 454B and the boom connecting pins 144a and 144b can be detected.

Alternatively, in a normal control, the control unit 530 can determine a failure of a detection device based on detection values of the first detection device 51 and the second detection device 52 while detecting information on the positions of the pair of cylinder connecting pins 454A and 454B and the pair of boom connecting pins 144a and 144b based on the detection value of the second detection device 52. As a result, the control unit 530 can quickly detect that a failure has occurred in at least one of the first detection device 51 and the second detection device 52.

In addition, in the present embodiment, since the first detection device 51 and the second detection device 52 are different in detection method, it is possible to suppress both detection devices from being simultaneously affected by noise. If the first detection device 51 and the second detection device 52 are identical in detection method, there is a possibility that the first detection device 51 and the second detection device 52 are simultaneously affected by noise. On the other hand, in the present embodiment, since the detection method of the first detection device 51 is different from the detection method of the second detection device 52, even in a case where one detection device is affected by noise, the other detection device is less likely to be simultaneously affected by the same. As a result, in the present embodiment, it is possible to suppress a state in which both the first detection device 51 and the second detection device 52 cannot detect the positions of the pair of cylinder connecting pins 454A and 454B and the boom connecting pins 144a and 144b (a state in which detection accuracy is low) due to the influence of noise.

### <Supplementary Note>

The technical idea disclosed in the specification and the drawings includes an invention obtained by combining the various configurations mentioned in the above-described embodiment in any manner. In particular, the technical idea disclosed in the specification and the drawings includes an invention obtained by applying the various configurations disclosed in the specification and the drawings to the basic configuration in any combination.

This application is based upon and claims the benefit of priority from Japanese Patent Application No. 2021-178083 filed on Oct. 29, 2021 and Japanese Patent Application No. 2022-98303 filed on Jun. 17, 2022, the entire contents of which are incorporated herein by reference.

### INDUSTRIAL APPLICABILITY

The present invention can be applied not only to a crane but also to various work machines (e.g., a high-place work vehicle) each including a telescopic boom.

### REFERENCE SIGNS LIST

1 Mobile crane
10 Vehicle body
12 Turning table
14 Telescopic boom
141 Distal boom
141a Cylinder pin receiving portion
141b Boom pin receiving portion
142 Intermediate boom
142a Cylinder pin receiving portion
142b First boom pin receiving portion
142c Second boom pin receiving portion
142d Third boom pin receiving portion
143 Proximal boom
144a, 144b Boom connecting pin
144c Pin-side receiving portion
16 Wire rope
17 Hook
2 Actuator
3 Telescopic cylinder
31 Rod member
32 Cylinder member
4 Pin moving mechanism
40 Trunnion
400 Fixed portion
401 Support hole
41 Electric motor
410 Cover
42 Brake mechanism
43 Transmission mechanism
431 Decelerator
432 Vertical transmission mechanism
432a Upper transmission shaft
432b Lower transmission shaft
45 Cylinder connecting mechanism
450 Switch gear
451 First rack bar
452 First gear mechanism
453 Second gear mechanism
454A, 454B Cylinder connecting pin
455 First biasing mechanism
455a, 455b Coil spring
46 Boom connecting mechanism
461a, 461b Second rack bar
461c Driving rack teeth portion
461g, 461h Locking claw portion
462 Synchronization gear
463 Second biasing mechanism
463a, 463b Coil spring
5 Position information detection device
50 Support
501 Right side plate
502 Left side plate
503 Rear side plate
504 Right side fixing plate
505 Left side fixing plate
506 Accommodation space
507 Positioning pin
51 First detection device
510 First detection object
510a First cylindrical surface
510b First flat surface
511 Second detection object
511a Second cylindrical surface
511b Second flat surface
512 First sensor
513 Second sensor
514 Third sensor
52 Second detection device
520 Detection object
521 Sensor
530 Control unit
54 Cover member

1. A work machine comprising:
a plurality of booms that are extended and retracted by motive power from an actuator;
a first pin that is moved by a first spring to connect the boom and the actuator to each other and is moved by motive power from a motor to release a connection of the boom and the actuator;
a second pin that is moved by a second spring to connect adjacent booms of the booms and is moved by motive power from the motor to release a connection of the adjacent booms; and
a first detection device and a second detection device that detect positions of the first pin and the second pin on the basis of a rotation of a rotary member that is rotated by motive power from the motor.

2. The work machine according to claim 1,
wherein the first detection device and the second detection device detect the positions of the first pin and the second pin by different detection methods.

3. The work machine according to claim 1, further comprising a support that supports the first detection device and the second detection device,
wherein the first detection device includes a first detection unit fixed around the rotary member via the support, and
the second detection device includes a second detection unit fixed around the rotary member via the support.

4. The work machine according to claim 3,
wherein the support includes a first plate portion extending in an axial direction of the rotary member and a second plate portion facing an end surface of the rotary member in the axial direction,
the first detection unit is fixed to the first plate portion, and
the second detection unit is fixed to the second plate portion.

5. The work machine according to claim 4, further comprising a cover member that covers an upper opening of the support,
wherein a lower opening of the support faces a surface of the actuator.

6. The work machine according to claim 3,
wherein the first detection unit is a proximity sensor, and
the second detection unit is a potentiometer.

7. The work machine according to claim 6,
wherein the first detection unit includes a plurality of the proximity sensors, and detects the positions of the first pin and the second pin on the basis of a combination of detection values of the plurality of proximity sensors.
